(19) United States
(12) Patent Application Publication
(10) Pub. No.: US 2025/0383923 A1
(43) Pub. Date: Dec. 18, 2025

(54) WORKLOAD SCHEDULING BASED ON VOLTAGE DROOP CHARACTERISTICS

(71) Applicant: Advanced Micro Devices, Inc., Santa Clara, CA (US)

(72) Inventors: Ashish JAIN, Austin, TX (US); Lakshminarayana PAPPU, Folsom, CA (US)

(21) Appl. No.: 18/746,006

(22) Filed: Jun. 17, 2024

(51) Int. Cl. G06F 9/50

(52) U.S. Cl. CPC G06F 9/5027

(57) ABSTRACT

Voltage droop is mitigated within an integrated circuit (IC) device including a first processing device and scheduler circuitry. The first processing device executes operations of a first workload. The first processing device is associated with a first processing device voltage droop characteristic. The scheduler circuitry receives the first workload. The first workload is associated with a first workload voltage droop characteristic. Further, the scheduler circuitry assigns the first workload to the first processing device of the IC device based on the first workload voltage droop characteristic and the first processing device voltage droop characteristic.

### TECHNICAL FIELD

Examples of the present disclosure generally relates to mitigating the effects of voltage droop within an integrated circuit device by assigning workloads based on voltage droop characteristics.

### BACKGROUND

Voltage droop corresponds to a loss in output voltage of a power supply signal. Voltage droop occurs when there is a change in the current associated with a load of the power supply signal. The change in current may be abrupt and lead to supply voltage drops across an integrated circuit (IC) device, which can cause performance errors within the IC device. Voltage droop reduces the performance of an IC device and/or cause timing failures within the IC device. The amount of voltage droop experienced by the circuit elements within an IC device is not the same across all the circuit elements. Further, the amount of voltage droop experienced is not the same across the workloads performed by the processing devices of an IC device.

Voltage droop can be mitigated by driving a higher voltage power supply signal. However, such a mitigation technique increases the power consumption of the corresponding IC devices. Further, voltage droop can be mitigated by decreasing the clock frequency of a clock signal driving the circuit elements when voltage droop is detected. However, decreasing the clock frequency decreases the performance of the IC device. Additionally, or alternatively, guard bands may be implemented within the IC device to mitigate the effects of voltage droop. However, guard bands increase the complexity of the IC device and limit the performance of the IC device. Accordingly, there is need for an improved voltage droop mitigation technique to improve the performance of IC devices.

### SUMMARY

In one example, an integrated circuit (IC) device includes a first processing device and scheduler circuitry. The first processing device executes operations of a first workload. The first processing device is associated with a first processing device voltage droop characteristic. The scheduler circuitry receives the first workload. The first workload is associated with a first workload voltage droop characteristic. Further, the scheduler circuitry assigns the first workload to the first processing device of the IC device based on the first workload voltage droop characteristic and the first processing device voltage droop characteristic.

In one example, a computing device includes a central processing device and an IC device. The IC device includes a first processing device and scheduler circuitry. The first processing device executes operations of a first workload. The first processing device is associated with a first processing device voltage droop characteristic. The scheduler circuitry receives the first workload from the central processing device. The first workload is associated with a first workload voltage droop characteristic. The scheduler circuitry assigns the first workload to the first processing device of the IC device based on the first workload voltage droop characteristic and the first processing device voltage droop characteristic.

In one example, a method includes receiving, at scheduler circuitry of integrated circuit (IC) device, a first workload. The first workload is associated with a first workload voltage droop characteristic. Further, the method includes assigning, via the scheduler circuitry, the first workload to a first processing device of the IC device based on the first workload voltage droop characteristic and a first processing device voltage droop characteristic associated with the first processing device. The method further includes executing an operation of the first workload with the first processing device.

These and other aspects may be understood with reference to the following detailed description.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a block diagram of an integrated circuit (IC) device.

FIG. 2 illustrates a flowchart of a method for mitigating voltage droop in an IC device assigning workloads to processing devices.

FIG. 3 illustrates a block diagram of a package device.

FIG. 4 illustrates a flowchart of a method for mitigating voltage droop in an IC device by assigning workloads to processing devices.

FIG. 5 illustrates a block diagram of a computer device.

FIG. 6 illustrates an example voltage droop gradient for an IC device.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

An integrated circuit (IC) device receives a power supply signal from power supply circuitry. Voltage droop may occur within the power supply signal due to fluctuations in the current load of the IC device. In an IC device, workload fluctuations may cause changes in the current of the corresponding power delivery network (PDN) within the IC device. A PDN at least includes the power supply circuitry that outputs the power supply signal and the routing between the power supply circuitry and a driven circuit element. The changes in the current cause voltage droop. Voltage droop causes voltage drop within the power supply signal, degrading the performance of an IC device, negatively affecting the energy efficiency of the IC device, and/or causing timing failures within the IC device. In one example, the location and/or size of capacitors within a package device including the IC device alters the voltage droop of each of the circuit elements within the IC device. Further, the voltage droop seen by different transistors of an IC device may be different due to local change in current over change in time (change in local di/dt) effects at different locations within the IC device. Local di/dt is a fast event, and can be characterized as “first droop” events, which happen at a nanosecond timescale. Further, local di/dt events differ from slower (e.g., microsecond timescale) droop events that are seen by the IC device, a packaged device including the IC device, and/or an external power supply. Slower droop events may be referred to as second or third droop events.

The circuit elements of an IC device are driven with a clock signal, or signals, generated by clock circuitry. As voltage droop may causes timing errors within the circuit elements, when voltage droop is detected, clock stretching is applied to a clock signal, or signals, reducing the frequency of the corresponding clock signal. Clock stretching reduces the frequency of the clock signal, reducing the operating frequency of the driven circuit elements, and mitigating the negative effects of voltage droop. However, as clock stretching reduces operating frequency, the performance of the IC device is degraded. Further, as clock stretching is based on voltage droop sensed relative to a location of sense points within an IC device, clock stretching may not account for the voltage droop that occurs in all regions of a corresponding IC device. Accordingly, as the amount of voltage droop in an IC device may be a gradient across the IC device, clock stretching may not be able to correct for voltage droop in all regions of an IC device.

Power supply circuitry may be designed to generate a power supply signal having a larger voltage headroom to account for possible voltage droop within the driven IC device. However, using such power supply circuitries negatively affect power efficiency of the corresponding IC device.

Guard bands may be used to mitigate the effects of voltage droop by reducing the maximum operating frequency of an IC device and/or increasing the minimum voltage of an IC device. However, reducing the maximum operating frequency of an IC device, reduces the performance of the IC device. Further, increasing the minimum voltage of the IC device increases the average power of the IC device, increasing the complexity and cost of the corresponding power supply circuitry and semiconductor device. Software guard bands may be used to limit the number of circuit elements (e.g., loads) are active during a common period. However, software guard bands increase the complexity of the IC device design, reducing the performance of the IC device.

In the following, an improved system and method for mitigating the negative effects of voltage droop is described. As is described in further detail below, an IC device includes processing devices. Workloads are assigned to the processing devices based on the voltage droop characteristics of the processing devices and/or the voltage droop characteristics of the workloads. The processing devices are characterized (graded) during the design and/or testing process of the corresponding IC device to determine the voltage droop characteristics of the processing devices. The workloads may be simulated to determine the voltage droop characteristics and/or analyzed before assignment to determine voltage droop characteristics. In one example, a processing device that is associated with a higher capacitance and/or lower inductance is assigned workloads associated with a larger voltage droop. In another example, a processing device that is closer to clock generation circuitry is assigned workloads associated with a larger voltage droop. Assigning workloads to processing devices based on the respective voltage droop characteristics, mitigates the negative effects of voltage droop, increasing the performance of the corresponding IC device.

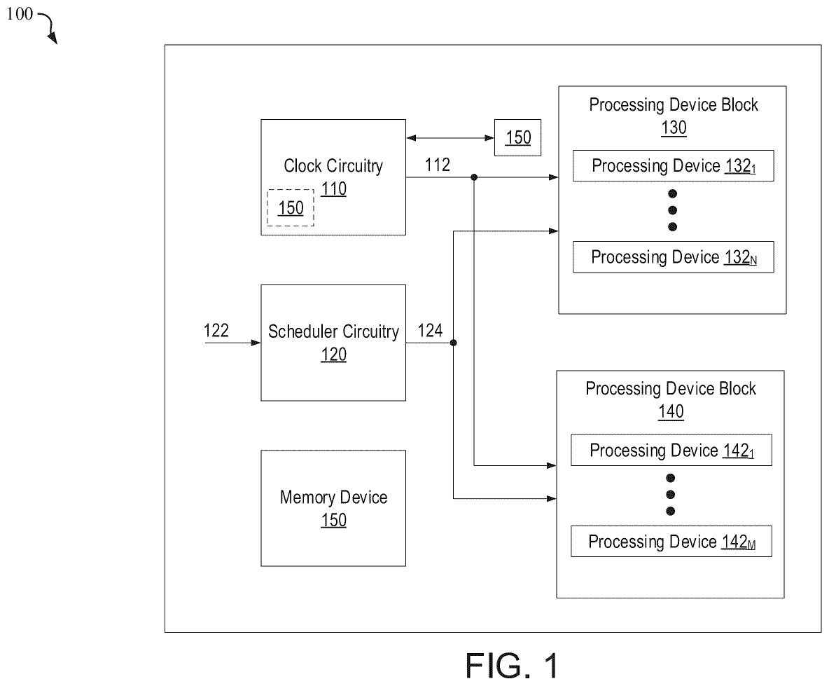

FIG. 1 illustrates a block diagram of an IC device 100. In one example, the IC device 100 may be a System-on-Chip (SoC). In or more examples, the IC device 100 is a central processing unit (CPU), a graphics processing unit (GPU), a hardware accelerator device, or another type of processing device. The IC device 100 is disposed within one or more dies (or chips). In an example, where two or more chips are used, the two or more chips are interconnected with each other (e.g., vertically mounted to each other and/or horizontally connected to each other via one or more interposers and/or one or more package substrates).

The IC device 100 includes clock circuitry 110, scheduler circuitry 120, processing device block 130, and processing device block 140. In other examples, the IC device 100 may include other circuit elements not illustrated in FIG. 1. The processing device block 130 includes processing devices 132. The processing device block 140 includes processing devices 142.

The clock circuitry 110 is coupled to the processing device block 130 and the processing device block 140. The clock circuitry 110 generates and outputs one or more clock signals 112 to the processing device block 130 and the processing device block 140. In one example, the clock circuitry 110 further outputs a clock signal 112 to the scheduler circuitry 120.

In one example, the IC device 100 is connected with and receives workloads 122 from one or more circuit devices. A circuit device is external to the IC device 100. Example circuit devices include, but are not limited to, a processing device (e.g., CPU, GPU, memory controller circuitry, or another type of processing device), a memory device, communication circuitry, or interface circuitry, among others.

The scheduler circuitry 120 is coupled to the processing device block 130 and the processing device block 140. The scheduler circuitry 120 receives workloads 122 and generates and outputs the control signal 124 to the processing device block 130 and the processing device block 140. The scheduler circuitry 120 receives the workloads 122 from one or more circuit devices. As is described in greater detail in the following, the scheduler circuitry 120 assigns the workloads 122 to the processing device block 130 and the processing device block 140 based on voltage droop characteristics of the workloads 122 and/or the voltage droop characteristics of the processing devices 132 and 142.

A voltage droop characteristic for a workload 122 (e.g., a workload voltage droop characteristic) corresponds to an amount of voltage droop a workload causes when the operations of the workload are executed. In one example, a voltage droop characteristic for a workload 122 corresponds to a change in current over time in an IC device caused when executing the operations of the workload.

A voltage droop characteristic for a processing device 132 or 142 (e.g., a processing device voltage droop characteristic) corresponds to inductance characteristics and/or capacitance characteristics associated with the processing device. For example, the capacitance characteristics include the capacitance of the corresponding PDN and/or the capacitance of circuit elements disposed proximate to the processing device. Further, the inductance characteristics include the inductance of the corresponding PDN and/or the inductance of circuit elements disposed proximate to the processing device. Additionally, or alternatively, the voltage droop characteristics for a processing device include a distance between the processing device and clock circuitry (e.g., the clock circuitry 110).

The processing device block 130 is a processor engine, an accelerator engine, or a shader engine, among others. The processing device block 130 includes the processing devices 1321-132N. N is two or more. A processing device 132 is a compute unit or a work group processor, among others. In one or more examples, a processing device 132 is a complex instruction set (CISC) microprocessor, a reduced instruction set computing (RISC) microprocessor, a very long instruction word (VLIW) microprocessor, or a processor implementing other instruction sets, or processors implementing a combination of instruction sets. In one example, a processing device 132 is a special purpose processing device such as an application specific integrated circuit (ASIC), a field programmable gate array (FPGA), a digital signal processor (DSP), a network processor, or the like. The processing devices 132 are configured to execute instructions associated with a workload 122 to perform the operations of the workload 122.

The processing device block 140 is configured similar to the processing device block 130. The processing device block 140 includes the processing devices 1421-142M. M is two or more. In one example, M is greater than, less than, or equal to N. The processing devices 142 are configured similar to the processing devices 132.

While FIG. 1 illustrates the IC device 100 including two processing device blocks 130 and 140, in other examples, an IC device may include more than or less than two processing blocks.

The IC device 100 further includes memory device 160. The memory device 160 stores the voltage droop characteristics of the processing devices 132 and 142 and/or the voltage droop characteristics of the workloads 122. In one example, the scheduler circuitry 120 access the memory device 160 to obtain the voltage droop characteristics of the processing devices 132 and 142 and/or the voltage droop characteristics of the workloads 122.

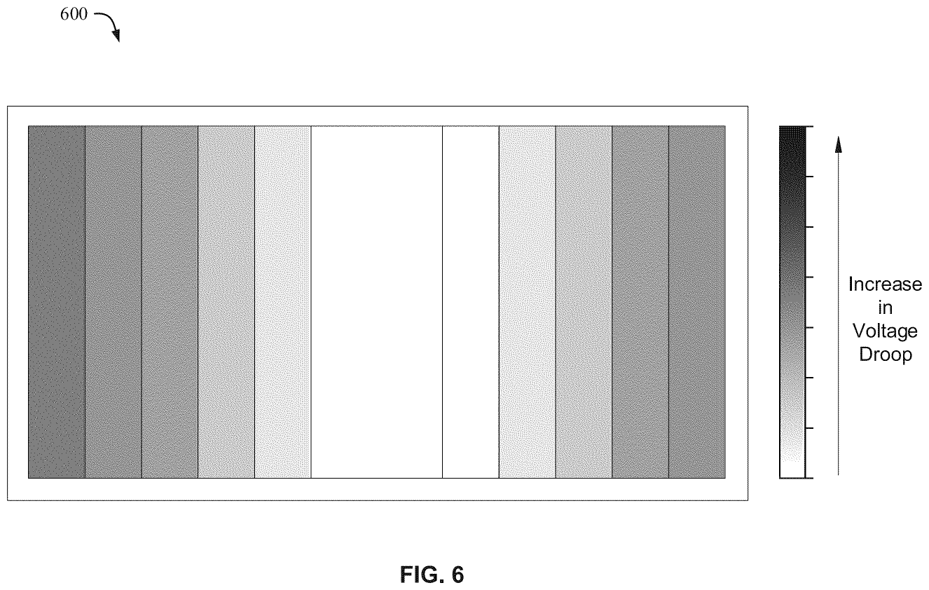

In one example, the amount of voltage droop in IC device 100 may be represented as a gradient across the IC device 100. FIG. 6 illustrates example voltage droop gradient 600 for the IC device 100. As can been seen from the voltage gradient 600, different regions of the IC device 100 experiences different amounts of voltage droop.

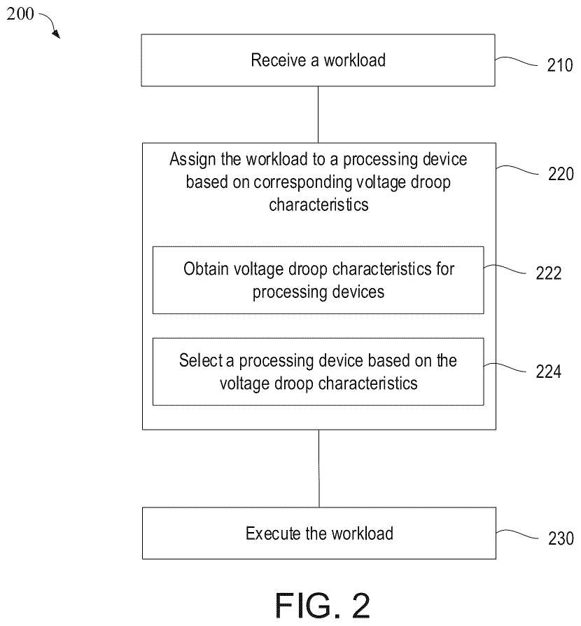

FIG. 2 illustrates a flowchart of a method 200 for assigning workloads to processing devices, according to one or more examples. In one example, the method 200 is at least partially performed by the IC device 100 of FIG. 1.

At 210 of the method 200, a workload is received. In one example, the scheduler circuitry 120 of FIG. 1 receives the workload 122. The scheduler circuitry 120 receives the workload 122 from one or more circuit devices. The scheduler circuitry 120 further obtains the voltage droop characteristics for the workload 122 (e.g., workload voltage droop characteristics). For example, the scheduler circuitry 120 obtains the voltage droop characteristic or characteristics for the workload 122 from the memory device 160. In one example, the workload 122 is simulated to determine the voltage droop characteristics for the workload 122. The workload 122 is simulated based on an example device based on the IC device 100. Simulating the workload 122 determines a change in current over time caused when the operations of the workload 122 are executed by an example a processing device or devices. The simulated voltage droop characteristics for the workload 122 are stored within the memory device 160. In another example, the scheduler circuitry 120, or other control circuitry of the IC device 100, examines the instructions (e.g., code) associated with the workload 122 to determine the voltage droop characteristics for the workload 122. For example, the instructions are examined to determine if the sequence instructions correspond to a low powered instruction set followed by a high power instruction set. A high power instruction set corresponds to an instruction set that does not include, or has a limited number of, memory access operations, and includes a majority of mathematical operations. A low power instruction set includes a larger number of memory access operations than a high power operation. The memory access operations act as gating operations. Switching between a high power instruction set and a low power instruction set causes a change in current over time, increasing the voltage droop of the corresponding workload 122. The voltage droop characteristics determined based on the sequence of instructions of the workload 122 are stored within the memory device 160.

In one example, the voltage droop characteristics for the workloads 122 are stored within the memory device 160 as a ranking. For example, the workloads 122 may be ranked based on the amount of voltage droop (e.g., from a low amount of voltage droop to a high amount of voltage droop, or from a high amount of voltage droop to a low amount of voltage droop) caused by the workloads and associated with the corresponding voltage droop characteristics.

At 220 of the method 200, the workload is assigned to a processing device based on corresponding voltage droop characteristics. For example with reference to FIG. 1, the scheduler circuitry 120 assigns the workload 122 to one or more of the processing devices 132 and 142 based on the voltage droop characteristics of the workload 122 and/or the voltage droop characteristics of the processing device 132 and 142.

In one example, assigning the workload to a processing device includes, 222 of the method 200, obtaining voltage droop characteristics for the processing devices 132 and 142 (e.g., processing device voltage droop characteristics). The scheduler circuitry 120 obtains the voltage droop characteristics for the processing device 132 and 142 from the memory device 160.

The voltage droop characteristics for a processing device 132/142 are determined by measuring the voltage droop within a power supply signal when a processing device 132/142 executes different operations. In one example, as voltage droop may not be constant across the IC device 100, the voltage droop caused by each of the processing devices 132/142 is measured. In one example, the voltage droop characteristics for a processing device 132/142 additionally, or alternatively, correspond to a distance between a processing device 132/142 and the clock circuitry 110 and/or voltage droop sensor circuitry 150. While the IC device 100 is shown as including one voltage droop sensor circuitry 150, in other examples, the IC device 100 may include more than one voltage droop sensor circuitry 150. Further, the location of the voltage droop sensor circuitry 150 may differ from that illustrated in FIG. 1. In one example, the clock circuitry 110 includes the voltage droop sensor circuitry 150. The voltage droop sensor circuitry 150 detects voltage droop within the IC device.

The clock circuitry 110 mitigates a larger amount of voltage droop within processing devices 132/142 that are closer to the clock circuitry 110 (e.g., have a smaller distance) and/or the voltage droop sensor circuitry 150 than processing devices 132/134 that are farther from the clock circuitry 110 (e.g., have a large distance) and/or the voltage droop sensor circuitry 150. In one example, the distance is a physical distance from the location of a processing device 132/142 to the voltage droop sensor circuitry 150. In one or more examples, the distance is a physical distance from the location of a processing device 132/142 to the location of the clock circuitry 110. In one example, the distance corresponds to the length of the corresponding electrical routings between the clock circuitry 110 and a processing device 132/142. In one example, the location of a processing device 132/142 corresponds to where the processing device 132/142 is disposed within the IC device 100, and the location of the clock circuitry 110 or the voltage droop circuitry 150 corresponds to where the clock circuitry 110 or the voltage droop circuitry 150 is disposed within the IC device 100. The distance may be a physical distance between the locations and/or the length of conductors (e.g., electrical connectors) within the IC device 100 that electrically couple the clock circuitry 110 with the processing device 132/142.

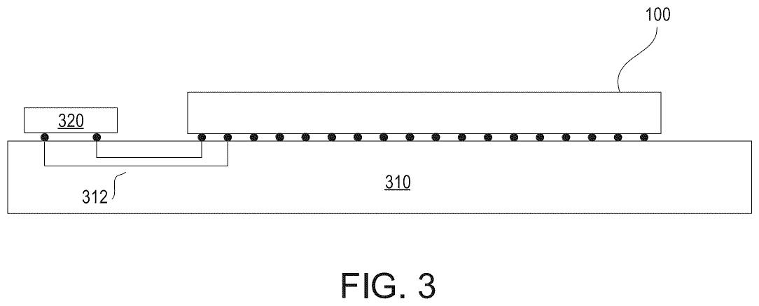

In one or more example, the voltage drop characteristics for a processing device 132/142 correspond to the inductance and/or capacitance along a PDN between the processing device and a power supply circuitry. FIG. 3 illustrates a package device 300. The package device 300 includes the IC device 100 and power supply circuitry 320 disposed on (mounted to) and connected via metal layers and via of a substrate 310. The power supply circuitry 320 is connected to the IC device 100 via electrical routings (e.g., traces) 312. A PDN includes the electrical routings 312 and corresponding connection elements of the power supply circuitry 320 and the IC device 100. The inductance and/or capacitance may correspond to the number of metal layers within the substrate 310. In another example, the capacitance may be the capacitance from physical capacitors within a packaged device including the IC device 100. In one example, the inductance and/or capacitance for the PDN of each processing device 132/142 is measured and stored as part of the corresponding voltage droop characteristic within the memory device 160. Processing devices having a higher functioning activity may increase the voltage droop for a processing device. Further, an inductance and capacitance of the PDN for each processing device 132 and 142 is measured within the IC device 100. The inductance and/or capacitance of the PDN for each processing device 132 and 142 is stored as part of the corresponding voltage droop characteristics within the memory device 160. Further, the inductance and/or capacitance of circuit elements disposed proximate the processing devices 132 and 142, and a functioning activity level of the circuit elements. In one example, circuit elements disposed proximate a processing device 132 and/or 142 that have a lower functioning activity level may operate as a charge store for nearby processing devices, decreasing the voltage droop for a processing device.

In one example, the voltage droop characteristics for the processing devices 132 and 142 are stored within the memory device 160 as a ranking. For example, the voltage droop characteristics are stored based on a ranking from a voltage droop characteristics that cause the least amount of droop to a voltage droop characteristic that causes a most amount of droop. In one example, the voltage droop characteristics are stored based on a ranking from a voltage droop characteristics that cause the most amount of droop to a voltage droop characteristic that causes a least amount of droop.

In one example, each processing device 132 and 142 is assigned a rank based on the corresponding voltage droop characteristic. A processing device 132 and 142 having a voltage droop characteristic associated with a larger amount of voltage droop may be assigned a rank greater than a processing device 132 and 142 having a voltage droop characteristic associated with a smaller amount of voltage droop. In one example, N is 4 and M is 4 such that the processing device block 130 and the processing device block 140 include 4 processing devices 132 and 142, respectively. The processing devices 132 and 142 are assigned a value of 1, 2, 3, or 4 within each corresponding processing device block 130 and 140 based on the corresponding voltage droop characteristic. For example, in the processing device block 130, a processing device 132 associated with the lowest amount of voltage droop is assigned a value (rank) of 1, and a processing device associated with the highest amount of voltage droop is assigned a value of 4. Further, in the processing device block 140, a processing device 142 associated with the lowest amount of voltage droop is assigned a value (rank) of 1, and a processing device associated with the highest amount of voltage droop is assigned a value of 4. The ranking is stored within the memory device 160. In one example, a processing device assigned a lowest rank value is the processing device within the processing device block that is the farthest from the clock circuitry 110, and a processing device assigned a highest rank value is the processing device within the processing device block that is the closest to the clock circuitry 110.

At 224 of the method 200, a processing device is selected based on the voltage droop characteristics. For example, the scheduler circuitry 120 of the IC device 100 selects a processing device based on the voltage droop characteristics for the processing device 132 and 142 and/or the voltage droop characteristic for the workload 122. In one example, a processing device 132 or 142 is selected based on the voltage droop characteristics for a workload falling within the voltage droop parameters of the voltage droop characteristics of the processing device. For example, a processing device 132 or 142 is selected based on a determination that the processing device 132 and 142 is able to perform the operations of the corresponding workload without errors and/or failures based a comparison of the voltage droop characteristics of the processing device to the voltage droop characteristics of the workload. In one or more examples, the scheduler circuitry 120 determines that the workload 122 causes a first amount of voltage droop from the voltage droop characteristics for the workload 122. The scheduler circuitry 120 selects one of the processing devices 132 and 142 is that is able to execute the operations of the workload 122 without failure or error when experiencing the first amount of voltage droop based on a comparison of the first amount of voltage droop and the respective voltage droop characteristics for the processing devices. In one example, if the workload 122 is determined to be associated with (e.g., cause) a high amount of voltage droop from the corresponding voltage droop characteristics, the scheduler circuitry 120 selects one of the processing devices 132 and 142 that is able to execute the workload 122 while supporting the corresponding amount of voltage droop. For example, a processing device 132 is selected that has a low amount of corresponding PDN inductance and/or that has a smaller distance to the clock circuitry 110 when the workload 122 is associated with a high amount of voltage droop.

In one example, the rankings of the workloads 122 and processing devices are used to select and assign processing devices for a workload. For example, a processing device 132 or 142 is selected that has a ranking that is at least equivalent to, or greater, than that of the workload 122. In one example, a workload 122 has a ranking of 3 in a ranking of scale of 1 (low) to 4 (high). The rankings of the processing devices 132 and 142 are analyzed (e.g., examined or processed) to determine a processing device that has a ranking of 3 or 4. A processing device 132 or 142 that has a ranking of 3 or 4 is selected and assigned the workload 122.

In one example, selecting a processing device at 224 includes selecting two or more processing devices 132 or 142 based on the corresponding voltage droop characteristics.

The scheduler circuitry 120 outputs the workload 122 to the selected processing device 132 or 142 via the control signals 124.

In one example, a first processing device 132 or 142 that is determined to be able to execute workload 122 based on the corresponding voltage droop characteristics is unavailable as the processing device is executing operations according to another workload. In such an example, the workload 122 is assigned to a second processing device 132 or 142 that is determined to be able to execute workload 122. In an example where no such processing device 132 or 142 is available that can meet the voltage droop characteristics of the workload, the scheduler circuitry 120 waits for such a processor device to become available or requests a higher voltage (or margin) on another processing device 132 or 142 before scheduling the workload on that processing device 132 or 142.

At 230 of the method 200, the workload is executed. For example, the selected processing device 132 or 142 receives the workload 122 from the scheduler circuitry 120, and executes the operations of the workload 122. In an example where multiple processing devices 132 or 142 are selected, each of the selected processing devices 132 or 142 perform at least a portion of the corresponding operations.

In one or more examples, the method 200 of FIG. 2 is repeated for each workload that is received. The method 200 may be continuously performed while the corresponding IC device is operating.

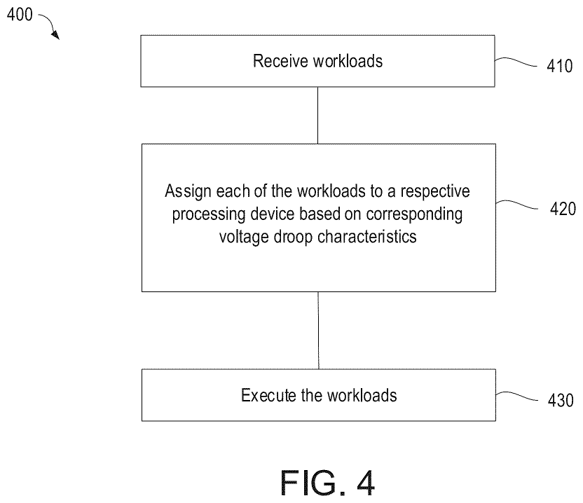

FIG. 4 illustrates a flowchart of a method 400 for assigning workloads to processing devices, according to one or more examples. In one example, the method 400 is at least partially performed by the IC device 100 of FIG. 1.

At 410 of the method 400, workloads are received. In one example, the scheduler circuitry 120 of FIG. 1 receives the workloads 122. In one or more examples, the scheduler circuitry 120 receives the workloads 122 from one or more circuit devices. The workloads 122 include two or more workloads. Two or more of the workloads 122 may be received serially with each other, or at least partially in parallel with each other. As is described above, each of the received workloads 122 has a corresponding voltage droop characteristic.

At 420 of the method 400, each of the workloads is assigned to a respective processing device based on corresponding voltage droop characteristics. The scheduler circuitry 120 assigns the workloads 122 as is described above with regard to 220 of the method 200 of FIG. 2. In one example, a first workload 122 is assigned to the processing device 1321 and a second workload 122 is assigned to the processing device 132N based on corresponding voltage droop characteristics as is described above with regard to 220 of the method 200 of FIG. 2. In one example, the first workload 122 is processed and assigned before the second workload is processed and assigned. In another example, the first and second workloads 122 are processed and assigned at least partially in parallel with each other. The first and second workloads 122 are assigned at least partially in parallel to the processing devices 132 and 142 via the control signals 124, or the first and second workloads are serially assigned to the processing devices 132 and 142 via the control signals 124.

At 430, the workloads are executed. The workloads are executed as described above with regard to 230 of the method 200 of FIG. 2.

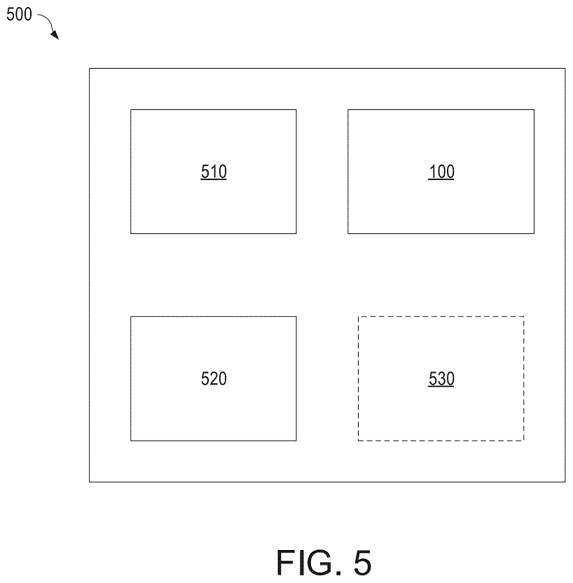

FIG. 5 is a schematic diagram of a computer device 500. The computer device 500 may be a personal computer device, a tablet device, a mobile device, a web appliance, a server, a network device (e.g., network router, a switch or bridge), or any computing device capable of executing a set of instructions. In one example, the computer device 500 is referred to as a host device.

The computer device (or computing device) 500 includes the IC device 100, a memory device 510, and interface circuitry 520. The memory device 510 is a read-only memory (ROM), flash memory, dynamic random access memory (DRAM) such as synchronous DRAM (SDRAM), a flash memory, or a static random access memory (SRAM), among others. The interface circuitry 520 transmits and receives data signals, another types of signals, to and from other computer devices. The interface circuitry 520 may be a wireless communication device and/or a wired communication device.

In one example, the computer device 500 further includes a CPU (or other type of processing device) 530. The CPU 530 may also be referred to as a central processing device. In such an example, the IC device 100 is a GPU. The memory device 510 stores instructions executable by the CPU 530 and/or the IC device 100 to perform one or more functions of the computer device 500. Further, the memory device 510 stores data to be used by the CPU 530 and/or the IC device 100.

In one example, the CPU 530 is omitted and an IC device 100 performs the functions of the CPU. Accordingly, the IC device 100 is referred to as a central processing device. In one more examples, the computer device 500 includes two or more IC devices 100. In such an example, the IC devices 100 perform similar functions or different functions. In one example, a first IC device 100 functions as a central processing device and a second IC device 100 functions as a GPU or another type accelerator device. In another example, each IC device 100 functions as a GPU.

In one example, the IC device 100 receives workloads from the CPU 530 or another processing unit. The IC device and assigns and executes the workloads as described above with regard to the method 200 of FIG. 2, and the method 400 of FIG. 4.

While the foregoing is directed to specific examples, other and further examples may be devised without departing from the basic scope thereof, and the scope thereof is determined by the claims that follow.

What is claimed is:

1. An integrated circuit (IC) device comprising:
a first processing device configured to execute operations of a first workload, the first processing device is associated with a first processing device voltage droop characteristic; and
scheduler circuitry configured to:
receive the first workload, the first workload associated with a first workload voltage droop characteristic; and
assign the first workload to the first processing device of the IC device based on the first workload voltage droop characteristic and the first processing device voltage droop characteristic.

2. The IC device of claim 1, wherein the first workload voltage droop characteristic corresponds to a sequence of instructions within the first workload.

3. The IC device of claim 1, wherein the first processing device voltage droop characteristic corresponds to at least one of capacitance characteristics and inductance characteristics of the IC device.

4. The IC device of claim 1 further comprising voltage droop sensing circuitry configured to sense voltage droop, wherein the first processing device voltage droop characteristic corresponds to a distance between the first processing device and the voltage droop sensing circuitry.

5. The IC device of claim 1, wherein the IC device is mounted to a package substrate, and wherein the first processing device voltage droop characteristic corresponds to at least one of capacitance characteristics and inductance characteristics of the package substrate.

6. The IC device of claim 1 further comprising:
second processing device associated with a second processing voltage droop characteristic, and wherein the scheduler circuitry is further configured to:
receive a second workload, the second workload associated with a second workload voltage droop characteristic; and
assign the second workload to the second processing device of the IC device based on the second workload voltage droop characteristic and the second processing voltage droop characteristic.

7. The IC device of claim 1, wherein assigning the first workload to the first processing device comprises determining that an amount of voltage droop associated with the first workload voltage droop characteristic is within voltage droop parameters of the first processing device voltage droop characteristic.

8. A computing device comprising:
A first circuit device; and
an integrated circuit (IC) device comprising:
a first processing device configured to execute operations of a first workload, the first processing device is associated with a first processing device voltage droop characteristic; and
scheduler circuitry configured to:
receive the first workload from the first circuit device, the first workload associated with a first workload voltage droop characteristic; and
assign the first workload to the first processing device of the IC device based on the first workload voltage droop characteristic and the first processing device voltage droop characteristic.

9. The computing device of claim 8, wherein the first workload voltage droop characteristic corresponds to a sequence of instructions within the first workload.

10. The computing device of claim 8, wherein the first processing device voltage droop characteristic corresponds to at least one of capacitance characteristics and inductance characteristics of the IC device.

11. The computing device of claim 8, wherein the IC device further comprises voltage droop sensing circuitry configured to sense voltage droop, and wherein the first processing device voltage droop characteristic corresponds to a distance between the first processing device and the voltage droop sensing circuitry.

12. The computing device of claim 8, wherein the IC device is mounted to a package substrate, and wherein the first processing device voltage droop characteristic corresponds to at least one of capacitance characteristics and inductance characteristics of the package substrate.

13. The computing device of claim 8, wherein the IC device further comprises;
second processing device associated with a second processing voltage droop characteristic, and wherein the scheduler circuitry is further configured to:
receive a second workload, the second workload associated with a second workload voltage droop characteristic; and
assign the second workload to the second processing device of the IC device based on the second workload voltage droop characteristic and the second processing voltage droop characteristic.

14. A method comprising:
receiving, at scheduler circuitry of integrated circuit (IC) device, a first workload, the first workload associated with a first workload voltage droop characteristic;
assigning, via the scheduler circuitry, the first workload to a first processing device of the IC device based on the first workload voltage droop characteristic and a first processing device voltage droop characteristic associated with the first processing device; and
executing an operation of the first workload with the first processing device.

15. The method of claim 14, wherein the first workload voltage droop characteristic corresponds to a sequence of instructions within the first workload.

16. The method of claim 14, wherein the first processing device voltage droop characteristic corresponds to at least one of capacitance characteristics and inductance characteristics of the IC device.

17. The method of claim 14, wherein the first processing device voltage droop characteristic corresponds to a distance between the first processing device and voltage droop sensing circuitry of the IC device, and wherein the voltage droop sensing circuitry is configured to sense voltage droop.

18. The method of claim 14, wherein the IC device is mounted to a package substrate, and wherein the first processing device voltage droop characteristic corresponds to at least one of capacitance characteristics and inductance characteristics of the package substrate.

19. The method of claim 14 further comprising:
receiving, at the scheduler circuitry, a second workload, the second workload associated with a second workload voltage droop characteristic; and
assigning, via the scheduler circuitry, the second workload to a second processing device of the IC device based on the second workload voltage droop characteristic and a second processing voltage droop characteristic associated with the second processing device.

20. The method of claim 14, wherein assigning the first workload to the first processing device comprises determining that an amount of voltage droop associated with the first workload voltage droop characteristic is within voltage droop parameters of the first processing device voltage droop characteristic.
